(19) United States
(12) Patent Application Publication
(10) Pub. No.: US 2010/0139604 A1
(43) Pub. Date: Jun. 10, 2010

(54) INLET MECHANISM FOR AN AIR INDUCTION SYSTEM

(76) Inventors: Reza Abdolhosseini, West Bloomfield, MI (US); Christopher Edward Shaw, Canton, MI (US)

Correspondence Address: FRASER CLEMENS MARTIN & MILLER LLC, 28366 KENSINGTON LANE, PERRYSBURG, OH, 43551, US

(21) Appl. No.: 12/330,919

(22) Filed: Dec. 9, 2008

(51) Int. Cl. F02M 35/10; F02M 35/12

(52) U.S. Cl. 123/184.56; 123/184.61

(57) ABSTRACT

An inlet mechanism for a vehicle air induction system is disclosed, the inlet mechanism including a main body disposed in a housing, wherein the main body is selectively positionable within the housing to control a volume of airflow therethrough over a range of engine speeds.

### FIELD OF THE INVENTION

The present invention relates generally to an air induction system and more particularly to an air induction system including an inlet mechanism for controlling air flow to an engine and engine induction noise emitted therefrom.

### BACKGROUND OF THE INVENTION

An internal combustion engine in a vehicle typically includes induction system for providing air to an engine. It is desirable to design the air induction system to maximize air flow to the engine, while minimizing noise emitted therefrom. One method to maximize air flow to the engine is to increase a size of a main air inlet orifice, which controls an amount of air permitted to flow into the system. However, increasing the size of the main inlet orifice typically increases induction noise generated as air is drawn into the system. Accordingly, matching a volume of air flow through the main inlet orifice to an engine speed is desirable. A particular volume of air flow through the main inlet orifice is optimum for each engine speed, a lower volume at lower engine speeds and a higher volume at higher engine speeds.

Typically, resonators and motorized binary inlet tubes of various types have been employed to reduce engine intake noise. Existing controlled variable tuned resonators vary resonator volume to achieve the desired noise reduction as a function of engine speed. While resonators have been effective at reducing induction noise, multiple resonators are frequently required. Further, volume control of the resonators requires movement of large sealed areas, which presents several problems that adversely affect engine performance such as increased motor load, for example.

It would be desirable to produce an inlet mechanism for the air induction system that is simple and does not require additional control devices to militate against the emission of noise caused by the vehicle engine induction process over a range of engine speeds.

### SUMMARY OF THE INVENTION

In concordance and agreement with the present invention, an inlet mechanism for the air induction system that is simple and does not require additional control devices to militate against the emission of noise caused by the vehicle engine induction process over a range of engine speeds, has surprisingly been discovered.

In one embodiment, the inlet mechanism comprises: a hollow housing adapted to facilitate a flow of a fluid therethrough; a main body disposed in the housing, the main body selectively positionable between an open position to permit the flow of the fluid through the housing and a closed position to militate against the flow of the fluid through the housing; and an urging member operatively engaged with the main body and cooperating with the main body to reach a desired position between the open position and the closed position.

In another embodiment, the inlet mechanism comprises: a hollow housing adapted to facilitate a flow of a fluid therethrough; a main body disposed in the housing, the main body including at least one slot formed therein, wherein the main body is selectively positionable between an open position to permit the flow of the fluid through the housing and a closed position to militate against the flow of the fluid through the housing; an urging member operatively engaged with the main body and cooperating with the main body to reach a desired position between the open position and the closed position; and a support disposed in the at least one slot of the main body.

In another embodiment, the inlet mechanism comprises: a hollow housing adapted to facilitate a flow of a fluid therethrough, the housing including an inlet having a neck formed therein and an outlet; a main body disposed in the housing, the main body including a first segment, a second segment, and a third segment, wherein the first segment and the second segment include at least one slot formed therein, and the third segment includes an annular collar having a plurality of threads formed therein, and wherein the main body is selectively positionable between an open position to permit the flow of the fluid through the housing and a closed position to militate against the flow of the fluid through the housing; an elongate member operatively engaged with the main body and cooperating with the main body to reach a desired position between the open position and the closed position, the elongate member having a plurality of threads formed thereon; an urging member disposed on the elongate member to control an axial movement of the main body in the housing; and a support including an inner ring, an outer ring, and at least one strut extending therebetween, wherein the inner ring slideably receives the elongate member and the at least one strut is disposed in the at least one slot to facilitate the axial movement of the main body in the housing.

### BRIEF DESCRIPTION OF THE DRAWINGS

The above, as well as other objects and advantages of the invention, will become readily apparent to those skilled in the art from reading the following detailed description of preferred embodiments of the invention when considered in the light of the accompanying drawings in which:

FIG. 1 is a cross-sectional side elevational view of an inlet mechanism for an air induction system according to an embodiment of the present invention, wherein a main body of the inlet mechanism is in a substantially closed position;

FIG. 2 is a cross-sectional side elevational view of the inlet mechanism illustrated in FIG. 1, wherein the main body of the inlet mechanism is in a substantially open position;

FIG. 3 is an exploded perspective view of the inlet mechanism illustrated in FIGS. 1 and 2;

FIG. 4 is a cross-sectional side elevational view of an inlet mechanism for an air induction system according to another embodiment of the present invention, wherein a main body of the inlet mechanism is in a substantially closed position;

FIG. 5 is a cross-sectional side elevational view of the inlet mechanism illustrated in FIG. 4, wherein the main body of the inlet mechanism is in a substantially open position; and

FIG. 6 is an exploded perspective view of the inlet mechanism illustrated in FIGS. 4 and 5.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

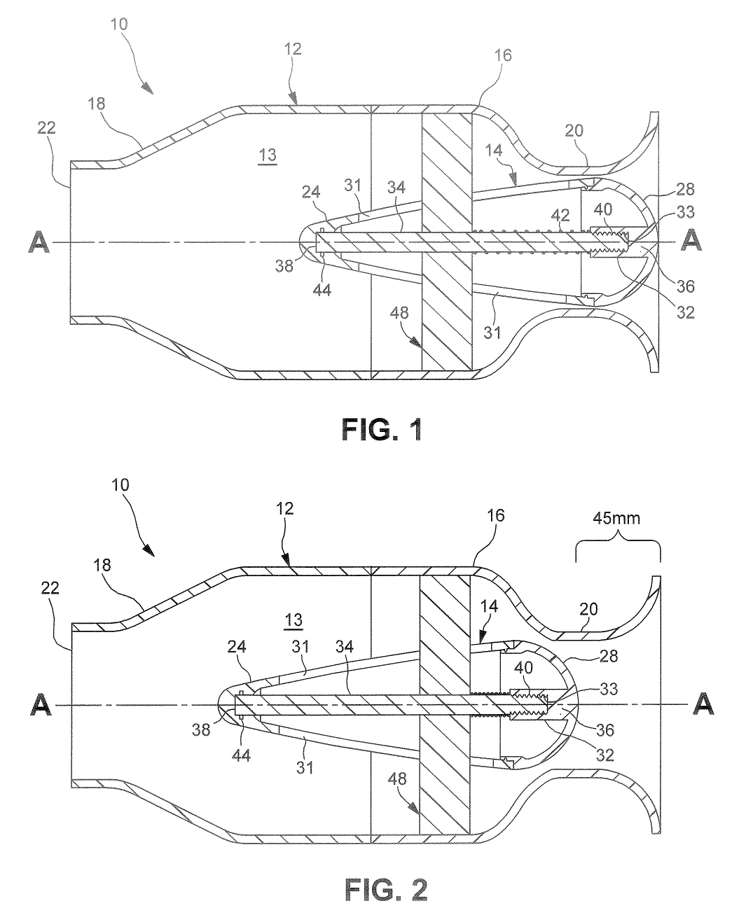

FIGS. 1, 2, and 3 show an inlet mechanism 10 for use with a vehicle air induction system (not shown) according to an embodiment of the invention. The inlet mechanism 10 includes a housing 12 having a hollow interior 13 with a main body 14 disposed therein. The housing 12 can be attached to the air induction system by any conventional method such as clamping, for example. In the embodiment shown, the housing 12 is produced from a plastic. It is understood that the housing 12 can be produced from any material as desired. The housing 12 has a generally circular cross-sectional shape and includes a first portion 16 and a second portion 18. It is understood that the housing 12 can have any shape as desired. The first portion 16 includes a neck 20 having an inlet in fluid communication with the atmosphere formed therein. The neck 20 is adapted to selectively receive at least a portion of the main body 14 therein. The second portion 18 includes an outlet 22 adapted to be coupled to an inlet (not shown) of the air induction system. The second portion 18 can be attached to the first portion 16 by any conventional method such as clamping, for example, or formed as a unitary structure.

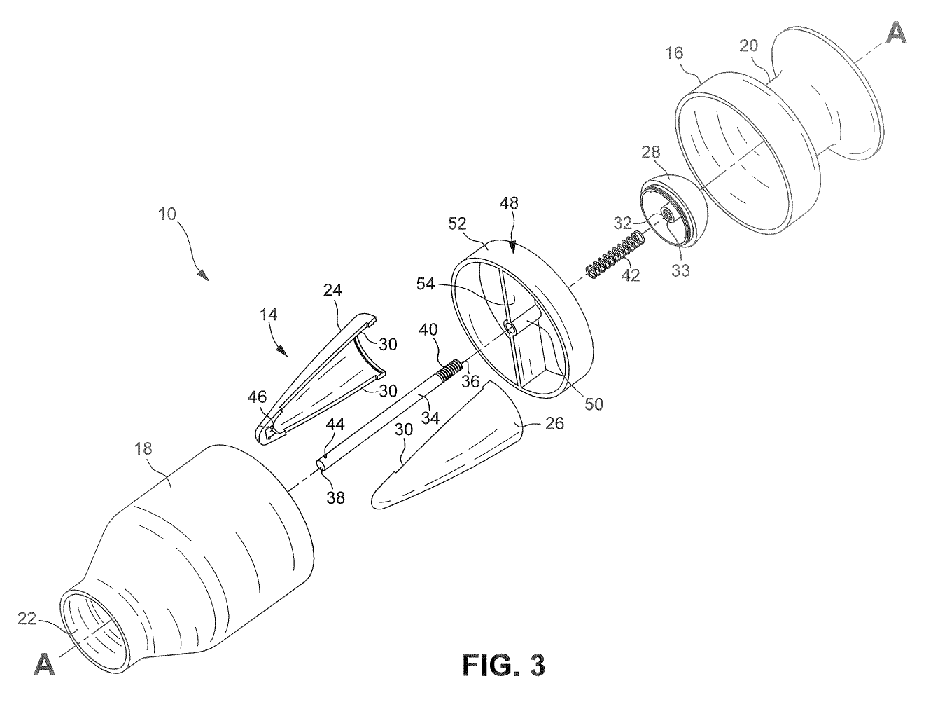

In the embodiment shown, the main body 14 is substantially ellipsoid shaped having an elongated end. Although the main body 14 shown is produced from a plastic, it is understood that the main body 14 can be produced from any material as desired such as a metal material, for example. The main body 14 includes a first segment 24, a second segment 26, and a third segment 28. It is understood that the segments 24, 26, 28 can be joined by any conventional means such as a snap fit, an epoxy, a fastener, and the like, for example. As shown in FIG. 3, each of the first segment 24 and the second segment 26 includes a pair of opposing indentations 30 formed therein. The indentations 30 of the first segment 24 substantially align and cooperate with the indentations 30 of the second segment 26 to form a pair of opposing slots 31. The slots 31 extend in a direction parallel to a longitudinal axis A of the main body 14. The third segment 28 is generally hemispherical in shape and is adapted to be coupled to an open end of the first segment 24 and the second segment 26. The third segment 28 includes an annular collar 32 having a plurality of internal threads 33 formed therein.

An elongate member 34 is disposed in the main body 14. It is understood that the elongate member 34 can have any shape as desired. In a non-limiting example, the elongate member 34 is produced from a plastic. In another non-limiting example, the elongate member 34 is produced from a metal material to add weight to the main body 14, thereby minimizing a vibration thereof. It is understood, however, that the elongate member 34 can be produced from any material d. The elongate member 34 includes a first end 36 and a second end 38. As illustrated, the first end 36 includes a plurality of external threads 40 formed thereon. The threads 40 are adapted to be received in the threads 33 of the annular collar 32.

An urging member 42 is disposed on the first end 36 of the elongate member 34. Although the urging member 42 shown is a helical spring, it is understood that the urging member 42 can be any urging member as desired. It is also understood that a resistance force of the urging member 42 influences an axial movement of the main body 14. The second end 38 of the elongate member 34 includes a pair of radially outwardly extending protuberances 44. Each of the protuberances 44 is adapted to be received in a corresponding cavity 46 formed in the first segment 24 and the second segment 26 of the main body 14. The protuberances 44 militate against relative axial movement between the elongate member 34 and the main body 14.

A support 48 disposed in the housing 12 is adapted to stabilize and position the main body 14 therein. In the embodiment shown, the support 48 is produced from a plastic. It is understood, however, that the support 48 can be produced from any material as desired such as a metal material, for example. The support 48 includes an inner ring 50, an outer ring 52, and an annular array of struts 54 extending therebetween. The inner ring 50 slideably receives the elongate member 34 therethrough to permit the axial movement of the main body 14 along the axis A. An outer surface of the outer ring 52 is fixedly attached to an inner surface of the housing 12 to militate against a rotational and a lateral movement of the main body 14 in respect of the axis A. The struts 54 extend radially outwardly from the inner ring 50 and through the slots 31 formed in the main body 14 to the outer ring 52. The slots 31 permit the axial movement of the main body 14 along the axis A, while militating against the rotational and the lateral movement thereof. One end of the urging member 42 abuts to at least one of the inner ring 50 and the struts 54.

It is understood that a damping element may be disposed in the main body 14 to minimize axial amplitude of any resonant oscillation of the main body 14.

In operation, air is received into the air induction system of the vehicle through the inlet mechanism 10. When the vehicle is idling or operated at low engine speeds, a rate of airflow into the air induction system, and more particularly the inlet mechanism 10, is minimized. At a minimum rate of airflow, the drag force on the main body 14 from the airflow is minimized. Accordingly, the urging member 42 is relatively unloaded and a resistance force thereof urges the main body 14 in a substantially closed position, as shown in FIG. 1. In the closed position, the main body 14 is disposed in the neck 20 of the housing 12. Accordingly, the inlet area of the neck 20 is minimized, permitting a substantially minimal volume of air to flow around the main body 14 and into the air induction system.

When the vehicle is operated at high engine speeds, the rate of airflow into the air induction system, and more particularly the inlet mechanism 10, is maximized. At a maximum rate of airflow, the drag force on the main body 14 from the airflow is maximized. Accordingly, the urging member 42 is fully loaded and the main body 14 is in a substantially open position, as shown in FIG. 2. In the open position, the main body 14 is urged axially from the neck 20 of the housing 12 in a first direction along the Axis A. Accordingly, the inlet area of the neck 20 is maximized, permitting a maximum volume of air to flow around the main body 14 and into the air induction system. In the embodiment shown, the open position of the main body 14 is a distance of about 45 mm from the closed position in the first direction. It is understood, however, that the open position of the main body 14 can be at any distance from the closed position as desired.

When the vehicle is operated at intermediate engine speeds, the rate of airflow into the air induction system, and more particularly the inlet mechanism 10, is at an intermediate rate between the minimum flow rate and the maximum flow rate. At an intermediate rate of airflow, the drag force on the main body 14 from the airflow is between the minimum force and the maximum force. Accordingly, the urging member 42 is loaded and the main body 14 is in a substantially intermediate position. In the intermediate position, the main body 14 is urged axially in the first direction along the Axis A. Accordingly, the inlet area of the neck 20 is between the minimum area and the maximum area, selectively permitting an intermediate volume of air to flow around the main body 14 and into the air induction system. In the embodiment shown, the intermediate position of the main body 14 is between a distance of about 0.0 mm to about 45 mm from the closed position. It is understood, however, that the intermediate position of the main body 14 can be at any distance between the open position and the closed position as desired.

It is further understood that as the rate of airflow into the inlet mechanism 10 the drag force on the main body 14 increases. Accordingly, the main body 14 axially translates in the first direction along the Axis A until a resistance force of the urging member 42 and the drag force of the main body 14 equilibrate.

In the embodiment shown, the main body 14 is calibrated by selectively threading the elongate member 34 to the third segment 28. Particularly, as more threads 40 are received into the threads 33 of the annular collar 32, a compression of the urging member 42 increases. Accordingly, an amount of drag force on the main body 14 from airflow through the housing 12 to initially move the main body 14 is increased.

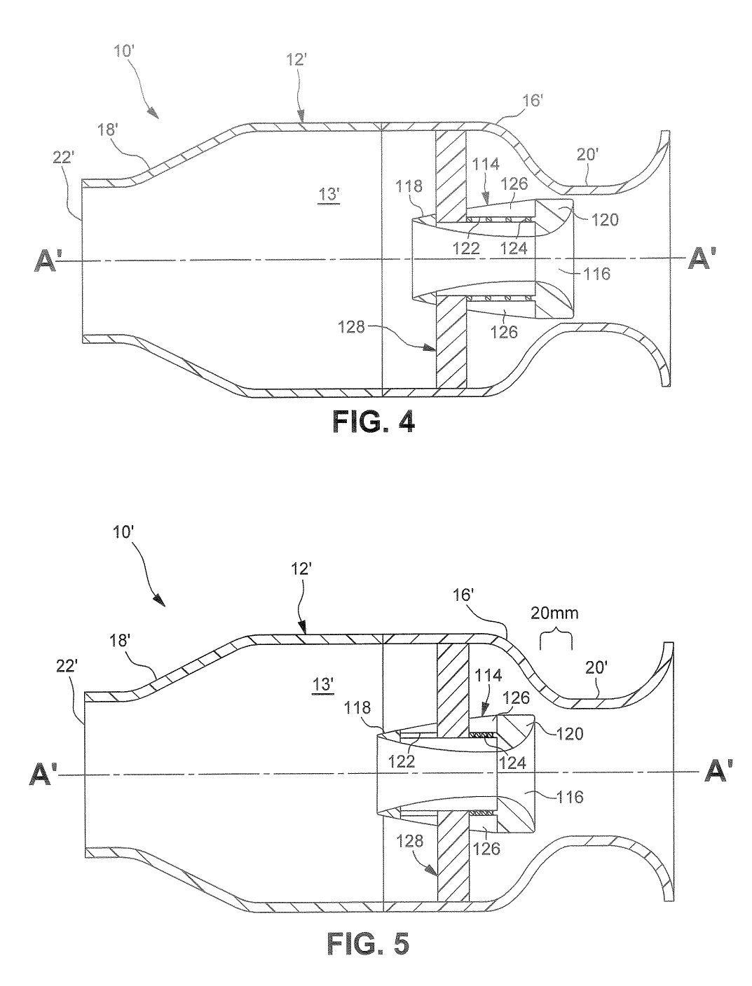

FIGS. 4, 5, and 6 show another embodiment of the invention which includes an inlet mechanism 10′ similar to the inlet mechanism 10 shown in FIGS. 1 thru 3. Reference numerals for similar structure in respect of the description of FIGS. 1 thru 3 are repeated in FIGS. 4 thru 6 with a prime (′) symbol.

The inlet mechanism 10′ shown is for use with a vehicle air induction system (not shown). The inlet mechanism 10′ includes a housing 12′ having a hollow interior 13′ with a main body 114 disposed therein. The housing 12′ can be attached to the air induction system by any conventional method such as clamping, for example. In the embodiment shown, the housing 12′ is produced from a plastic. It is understood that the housing 12′ can be produced from any material as desired. The housing 12′ has a generally circular cross-sectional shape and includes a first portion 16′ and a second portion 18′. It is understood that the housing 12′ can have any shape as desired. The first portion 16′ includes a neck 20′ having an inlet in fluid communication with the atmosphere formed therein. The neck 20′ is adapted to selectively receive at least a portion of the main body 114 therein. The second portion 18′ includes an outlet 22′ adapted to be coupled to an inlet (not shown) of the air induction system. The second portion 18′ can be attached to the first portion 16′ by any conventional method such as clamping, for example, or formed as a unitary structure.

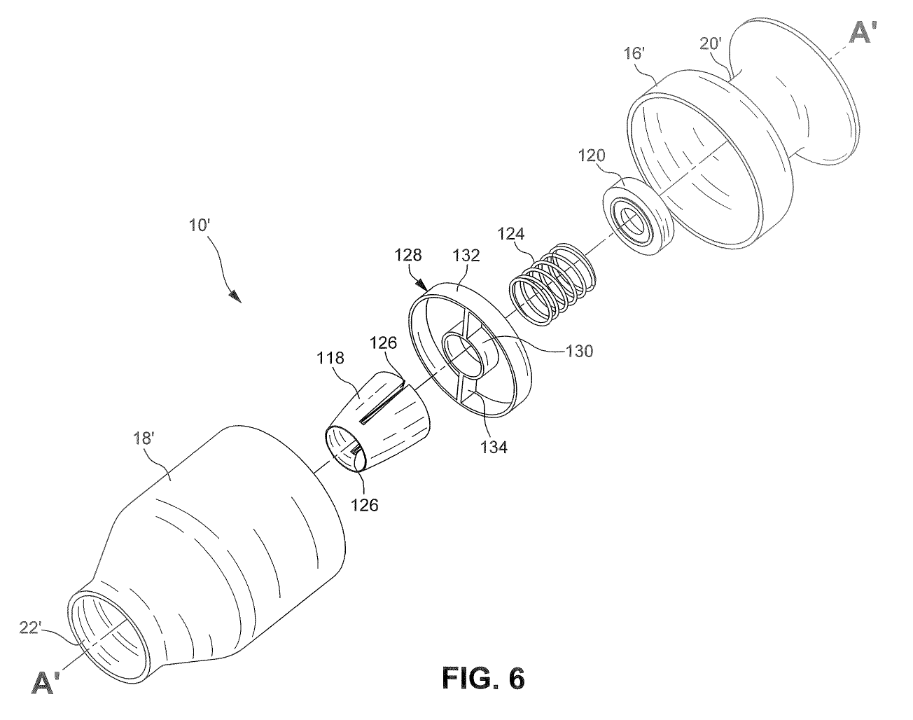

In the embodiment shown, the main body 114 is substantially cylindrical shaped having a venturi passage 116 formed therein. Although the main body 114 shown is produced from plastic, it is understood that the main body can be produced from any material as desired such as a metal material, for example. The main body 114 includes a first segment 118 and a second segment 120. It is understood that the segments 118, 120 can be joined by any conventional means such as a snap fit, an epoxy, a fastener, and the like, for example. The first segment 118 includes an annular opening 122, as shown in FIGS. 4 and 5. The opening 122 is adapted to receive an urging member 124 therein. Although the urging member 124 shown is a helical spring, it is understood that the urging member 124 can be any urging member as desired. It is also understood that a resistance force of the urging member 124 influences an axial movement of the main body 114. One end of the urging member 124 abuts the second segment 120. As shown in FIG. 6, the first segment 118 further includes a pair of opposing slots 126. The slots 126 are formed to extend in a direction parallel to a longitudinal axis A′ of the main body 114.

A support 128 disposed in the housing 12′ is adapted to stabilize and position the main body 114 therein. In the embodiment shown, the support 128 is produced from a plastic. It is understood, however, that the support 128 can be produced from any material as desired such as a metal material, for example. The support 128 includes an inner ring 130, an outer ring 132, and an annular array of struts 134 extending therebetween. The inner ring 130 is received in the opening 122 to permit the axial movement of the main body 114 along the axis A′. An outer surface of the outer ring 132 is fixedly attached to an inner surface of the housing 121 to militate against a rotational and a lateral movement of the main body 114 in respect of the axis A′. The struts 134 extend radially outwardly from the inner ring 130 and through the slots 126 formed in the main body 114 to the outer ring 132. The slots 126 permit the axial movement of the main body 114 along the axis A′, while militating against the rotational and the lateral movement thereof. Another end of the urging member 124 abuts at least one of the inner ring 130 and the struts 134.

It is understood that a damping element may be disposed in the main body 114 to minimize axial amplitude of any resonant oscillation of the main body 114.

In operation, air is received into the air induction system of the vehicle through the inlet mechanism 10′. When the vehicle is idling or operated at low engine speeds, a rate of airflow into the air induction system, and more particularly the inlet mechanism 10′, is minimized. At a minimum rate of airflow, a drag force on the main body 114 from the airflow is minimized. Accordingly, the urging member 124 is relatively unloaded and a resistance force thereof urges the main body 114 in a substantially closed position, as shown in FIG. 4. In the closed position, the main body 114 is disposed in the neck 20′ of the housing 12′. Accordingly, the inlet area of the neck 20′ is minimized, permitting a substantially minimal volume of air to flow around and through the main body 114 and into the air induction system.

When the vehicle is operated at high engine speeds, the rate of airflow into the air induction system, and more particularly the inlet mechanism 10′, is maximized. At a maximum rate of airflow, the drag force on the main body 114 from the airflow is maximized. Accordingly, the urging member 124 is fully loaded and the main body 114 is in a substantially open position, as shown in FIG. 5. In the open position, the main body 114 is urged axially from the neck 20′ of the housing 12′ in a first direction along the Axis A′. Accordingly, the inlet area of the neck 20′ is maximized, permitting a maximum volume of air to flow around and through the main body 114, and into the air induction system. In the embodiment shown, the open position of the main body 114 is a distance of about 20 mm from the closed position. It is understood, however, that the open position of the main body 114 can be at any distance from the closed position as desired.

When the vehicle is operated at intermediate engine speeds, the rate of airflow into the air induction system, and more particularly the inlet mechanism 10′, is at an intermediate rate between the minimum flow rate and the maximum flow rate. At an intermediate rate of airflow, the drag force on the main body 114 from the airflow is between the minimum amount of force and the maximum amount of force. Accordingly, the urging member 124 is loaded and the main body 114 is in a substantially intermediate position. In the intermediate position, the main body 114 is urged axially in the first direction along the Axis A′. Accordingly, the inlet area of the neck 20′ is between the maximum area and the minimum area, permitting an intermediate volume of air to flow around and through the main body 114, and into the air induction system. In the embodiment shown, the intermediate position of the main body 114 is between a distance of about 0.0 mm to about 20 mm from the closed position. It is understood, however, that the intermediate position of the main body 114 can be at any distance between the open position and the closed position as desired.

It is further understood that as the rate of airflow into the inlet mechanism 10′ increases, the drag force on the main body 114 increases. Accordingly, the main body 114 axially translates in the first direction along the Axis A′ until a resistance force of the urging member 124 and the drag force of the main body 114 equilibrate.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. An inlet mechanism, comprising:
a hollow housing adapted to facilitate a flow of a fluid therethrough;
a main body disposed in the housing, the main body selectively positionable between an open position to permit the flow of the fluid through the housing and a closed position to militate against the flow of the fluid through the housing; and
an urging member operatively engaged with the main body and cooperating with the main body to reach a desired position between the open position and the closed position.

2. The inlet mechanism according to claim 1, wherein the main body includes at least one slot formed therein to permit the main body to reach the desired position between the open position and the closed position.

3. The inlet mechanism according to claim 1, wherein the main body is an ellipsoid having an elongated end.

4. The inlet mechanism according to claim 1, wherein the main body is generally cylindrical in shape having a venturi passage formed therein.

5. The inlet mechanism according to claim 1, wherein the main body includes an elongate member disposed therein to receive the urging member thereon to control an axial movement of the main body in the housing.

6. The inlet mechanism according to claim 1, wherein at least one of the housing and the main body are produced from a plastic.

7. An inlet mechanism comprising:
a hollow housing adapted to facilitate a flow of a fluid therethrough;
a main body disposed in the housing, the main body including at least one slot formed therein, wherein the main body is selectively positionable between an open position to permit the flow of the fluid through the housing and a closed position to militate against the flow of the fluid through the housing;
an urging member operatively engaged with the main body and cooperating with the main body to reach a desired position between the open position and the closed position; and
a support disposed in the at least one slot of the main body.

8. The inlet mechanism according to claim 7, wherein the main body is an ellipsoid having an elongated end.

9. The inlet mechanism, according to claim 7, wherein the main body is generally cylindrical in shape having a venturi passage formed therein.

10. The inlet mechanism according to claim 7, wherein the main body includes an elongate member disposed therein to receive the urging member thereon to control an axial movement of the main body in the housing.

11. The inlet mechanism according to claim 7, wherein at least one of the housing, the main body, and the support are produced from a plastic.

12. The inlet mechanism according to claim 7, wherein the support is attached to the housing to militate against a lateral movement and a rotational movement of the main body.

13. The inlet mechanism according to claim 7, wherein the support includes an inner ring, an outer ring, and at least one strut extending therebetween.

14. An inlet mechanism comprising:
a hollow housing adapted to facilitate a flow of a fluid therethrough, the housing including an inlet having a neck formed therein and an outlet;
a main body disposed in the housing, the main body including a first segment, a second segment, and a third segment, wherein the first segment and the second segment include at least one slot formed therein, and the third segment includes an annular collar having a plurality of threads formed therein, and wherein the main body is selectively positionable between an open position to permit the flow of the fluid through the housing and a closed position to militate against the flow of the fluid through the housing;
an elongate member operatively engaged with the main body and cooperating with the main body to reach a desired position between the open position and the closed position, the elongate member having a plurality of threads formed thereon;
an urging member disposed on the elongate member to control an axial movement of the main body in the housing; and
a support including an inner ring, an outer ring, and at least one strut extending therebetween, wherein the inner ring slideably receives the elongate member and the at least one strut is disposed in the at least one slot to facilitate the axial movement of the main body in the housing.

15. The inlet mechanism according to claim 14, wherein the main body is an ellipsoid having an elongated end.

16. The inlet mechanism according to claim 14, wherein at least one of the housing, the main body, and the support are produced from a plastic.

17. The inlet mechanism according to claim 14, wherein the elongate member is produced from one of a plastic and a metal.

18. The inlet mechanism according to claim 14, wherein the outer ring of the support is attached to the housing to militate against a lateral movement and a rotational movement of the main body.

19. The inlet mechanism according to claim 14, wherein the threads of the annular collar are adapted to cooperate with the threads of the elongate member.

20. The inlet mechanism according to claim 14, wherein the outlet of the housing is in fluid communication with an air induction system of a vehicle.
